(19) United States
(12) Patent Application Publication
(10) Pub. No.: US 2012/0113104 A1
(43) Pub. Date: May 10, 2012

(54) TABLE TYPE INTERACTIVE 3D SYSTEM

(75) Inventors: Kwang Mo Jung, Gyeonggi-do (KR); Sung Hee Hong, Seoul (KR); Byoung Ha Park, Seoul (KR); Young Choong Park, Seoul (KR); Kwang Soon Choi, Gyeonggi-do (KR); Yang Keun Ahn, Seoul (KR); Hoonjong Kang, Gyeonggi-do (KR)

(73) Assignee: KOREA ELECTRONICS TECHNOLOGY INSTITUTE, Gyeonggi-do (KR)

(21) Appl. No.: 13/288,239

(22) Filed: Nov. 3, 2011

(30) Foreign Application Priority Data
Nov. 5, 2010 (KR) 10-2010-0109691

(51) Int. Cl. G06T 15/00

(52) U.S. Cl. 345/419

(57) ABSTRACT

A table type 3D video display device and a table type interactive user interface are disclosed. More particularly, a method for providing services such as games, education, shopping, virtual experience, or the like, of a 3D type is disclosed. The interactive 3D system of the present invention includes a table type 3D display module 210 displaying 3D videos; a spatial touch recognition module 200 monitoring a position of user's fingers interacting with the displayed 3D videos; and an interaction computing module 230 controlling the 3D display module and the spatial touch recognition module 200.

### RELATED APPLICATIONS

This application claims priority to Korean Patent Application No. 10-2010-0109691, filed on Nov. 5, 2010, entitled, “Interactive 3D System Of Table Type,” which is incorporated herein by reference in its entirety.

### FIELD OF THE INVENTION

The present invention relates to a table type 3D video display device and a table type interactive user interface, and more particularly, to a method for providing services such as games, education, shopping, virtual experiences, or the like, of a 3D type.

### DESCRIPTION OF RELATED ART

Generally, a human perceives a three-dimensional effect of video by watching 3D videos with human eyes. The 3D videos are captured by two cameras or a camera to which a twin lens is attached. Herein, one indicates a left eye and the other indicates a right eye. The two lenses are spaced apart from each other by about 6.3 cm, which corresponds to a gap between human eyes. In this case, the captured video is projected on a screen by two simultaneous projectors. A user needs to wear eyeglasses having different color tones or polarized eyeglasses so as to watch videos of a left eye and a right eye in sequence that the videos are displayed. Realistically, the user separately watches videos. However, two slightly different videos are converged in a brain of a spectator, which are perceived in a stereoscopic manner.

As described above, the 3D videos may be generated by using a plurality of cameras and the polarized eyeglasses or may be generated without using the polarized eyeglasses.

FIG. 1 is a view showing a table type display outputting the existing 3D videos without using eyeglasses. As shown in FIG. 1, existing 3D videos can be three-dimensionally watched in all directions (360 degrees) without using the polarized eyeglasses.

However, the system has a function of simply reproducing the produced videos and does not include a function of creating a feeling as if the user can manipulate or touch videos. In addition, the system can output a small-sized video, such that there are few interactive factors that can be felt and experienced by the user.

### SUMMARY OF THE INVENTION

Accordingly, it is an object of the present invention to provide an interactive 3D video system capable of communicating a 3D video system with a user.

Another object of the present invention is to provide a method capable of allowing a user to get a feeling as if he/she can manipulate or touch 3D videos displayed by a 3D video system.

Another object of the present invention is to provide a system capable of creating a sense of virtual reality much stronger than that of a 3D video display system according to the related art.

According an exemplary embodiment of the present invention, there is provided an interactive 3D system, including: a table type 3D display module displaying 3D videos; a spatial touch recognition module monitoring a position of user's fingers interacting with the displayed 3D videos; and an interaction computing module controlling the 3D display module and the spatial touch recognition module.

According another exemplary embodiment of the present invention, there is provided a table type 3D display module displaying 3D videos; a spatial touch recognition module monitoring a position of user's fingers interacting with the displayed 3D videos; an interaction computing module controlling the 3D display module and the spatial touch recognition module; and a spatial tactile stimulus module providing tactile information with the fingers when the user's fingers interacting with the displayed 3D videos are positioned at a specific point.

As set forth above, the interactive 3D system according to the exemplary embodiments of the present invention can be used in various home 3D fields such as 3D e-shopping, 3D education, 3D entertainment, 3D games, or the like.

In addition, interactive 3D technology can promote industrialization by improving the completeness of each technology element such as the 3D displays, 3D sensors, 3D convergence technology, 3D contents, or the like. Further, through the interactive 3D technology, information appliances and IT products of a new concept that converge with more realistic technology can be derived. In addition, the interactive 3D technology can expand high value-added industries by activating the high-quality digital contents industries relating to interactive 3D audio/video services and increase employment and create the new entertainment service cultures in conjunction with experts relating to production, edition, and distribution of high-quality digital multimedia contents. Further, the interactive 3D technology can produce the 3D contents for children and teenagers in the case of the education industry to allow children and teenagers to indirectly experience environments, that cannot be experienced in a classroom, through the use of 3D videos and provide advanced education services by actively utilizing the contents of experiments and indirect experiences rather than using the framework of the existing education system which depends on textbooks and notes in the case of university education.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a table type display outputting existing 3D videos without using eyeglasses;

FIG. 2 is a block diagram showing a table type interactive 3D system according to an exemplary embodiment of the present invention; and

FIG. 3 is a view showing an example in which a user touches videos displayed by a table type 3D display module in the table type interactive 3D system according to the exemplary embodiment of the present invention.

### DETAILED DESCRIPTION OF THE INVENTION

The foregoing and additional aspects of the exemplary embodiment of the present invention will be more apparent through exemplary embodiments of the present invention described with reference to the accompanying drawings. Hereinafter, the exemplary embodiments of the present invention will be described in detail so as to be easily understood and reproduced by a person skilled in the art to which the present invention pertains.

Recently, a technology of using an operation recognition function has been developed in several countries, but an interactive 3D related core original technology is still under development. The interactive 3D related core original technology may include a free visual 3D technology, a time of flight (TOF) 3D sensor technology, a non-contact spatial tactile technology, and a contextual 3D object processing technology, or the like.

That is, with the development of IT technology, the interest and marketability of 3D technology are continuing to increase. As new industries, a 3D convergence industry has emerged. In addition, a 3D related market has been restrictively formed in a market of special fields, such as exhibition halls, experience rooms, theaters, or the like, that are used by the public. However, the 3D related market has been expanded to information home appliances that may be used by individuals due to the convergence with the 3D interaction function, such that large industries may make significant developments.

Interactive 3D technology may create new business models for home network information home appliance industries. In addition, when the interactive user interface (UI) technology is applied to 3D videos, the 3D videos are intuitive and easily manipulated such that the user can feel sense of reality and interest at the time of the manipulation. As a result, the user can feel analog emotion using digital devices.

To this end, the exemplary embodiment of the present invention proposes an interactive 3D system of a free visual type (table type) using a table type free visual 3D display technology, a super VGA (including video graphics array (VGA), and Quarter VGA (QVGA)) TOF spatial sensor technology, a non-contact type spatial tactile stimulus technology, and an interactive 3D middleware technology, so as to provide services such as games, education, shopping, virtual experience, or the like, of the interactive 3D type.

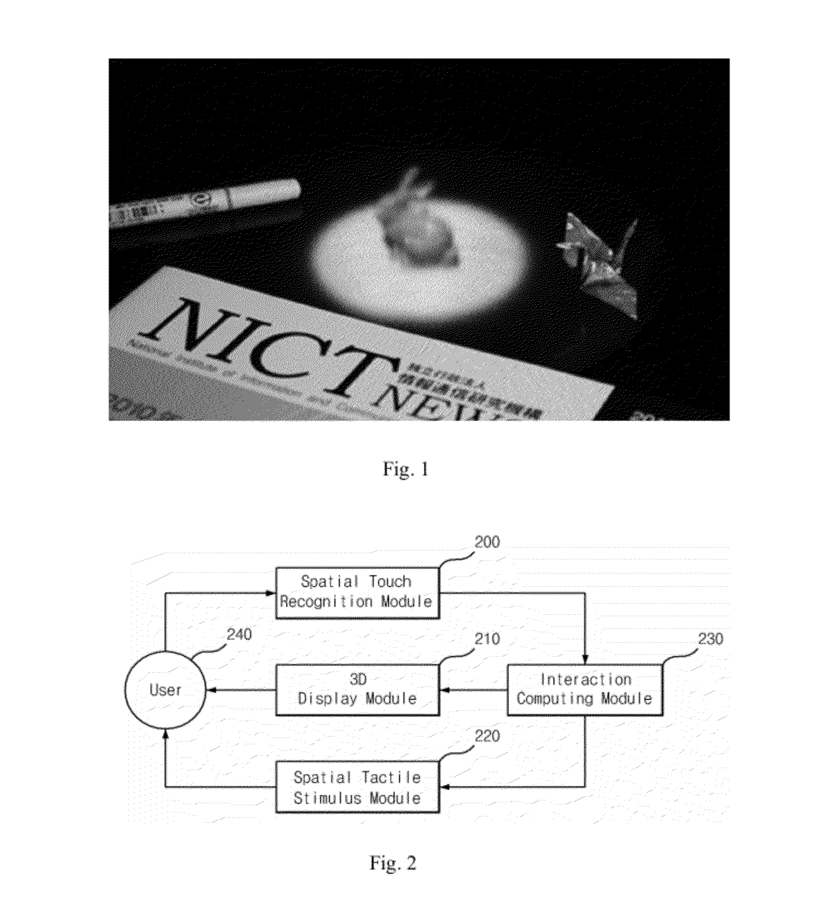

FIG. 2 is a block diagram showing a table type interactive 3D system according to an exemplary embodiment of the present invention. Hereinafter, the table type interactive 3D system according to the exemplary embodiment of the present invention will be described in detail with reference to FIG. 2.

The table type interactive 3D system recognizes a motion of a body based on autostereoscopic 3D videos that can be freely visualized in all directions to provide the 3D videos and the interactive function and the non-contact spatial tactile function.

To this end, the table type interactive 3D system according to the exemplary embodiment of the present invention includes a 3D display module 210, a space touch recognition module 200, a spatial tactile stimulus module 220, and an interaction computing module 230. In addition, it is apparent that other components other than the above-mentioned components may be included in the interactive 3D system.

A user 240 recognizes the 3D videos displayed by the 3D display module 210. The 3D display module 210 implements the table type 3D display function and a flash hologram display function. The table type free visual 3D display is a free visual 3D display of a table type rather than a general display to be hung on a wall. That is, the user can get a feeling of manipulating objects by displaying a virtual 3D object horizontally existing on the table like actually existing on the table.

The exemplary embodiment of the present invention may include a flash hologram display module implementing the flash hologram display function, in addition to the 3D display module 210. The flash hologram display module may be simultaneously used with the 3D display module 210 that is a main component in the table type interactive 3D system and performs a function of displaying a partially complete multi-view 3D object.

Generally, a hologram means a 3D picture generated by a holography and consists of recording an interference pattern of light from a laser beam, or the like, on a recording medium such as a film, a photosensitive plate, or the like. Holography, which is an ideal display type for implementing stereoscopic image, records interference signals due to the overlapping of light from a subject and reference light having coherence. The hologram reproduces the 3D video of any targeted object.

The spatial touch recognition module 200 recognizes whether the user 240 touches the videos displayed by the 3D display. That is, the spatial touch recognition module 200 recognizes the motion or hand motion of the user 240 to implement a high-precision 3D spatial sensing function so as to be interwork with the 3D object. An example of the spatial touch recognition module 200 may include a TOF type high-resolution 3D depth sensor module. While the 3D depth sensor module has problems of interference due to lighting, it can analyze the space in real time to perform the interaction.

Being described in detail, the 3D depth sensor module configures a front part and includes an infrared pulse output unit and an infrared pulse receiving unit. The infrared pulse output unit outputs the infrared pulse from the front part of the 3D depth sensor module and the infrared pulse input unit receives the infrared pulse reflected and returned from objects among the infrared pulses output from the infrared pulse output unit. The 3D depth sensor module measures the time when the infrared pulses output from the infrared pulse output unit are reflected and returned from objects. The 3D depth sensor module calculates a distance from objects using the measured time.

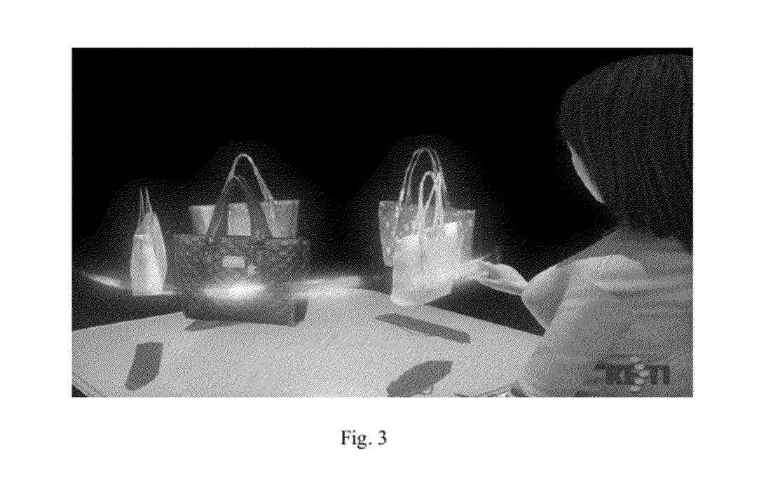

FIG. 3 is a view showing an example in which the user touches the videos displayed by the 3D display module 210 in the table type interactive 3D system according to the exemplary embodiment of the present invention. As described above, the spatial touch recognition module 200 recognizes the space in which the user touches the displayed videos, so as to use the information thereon.

The spatial tactile stimulus module 220 provides whether the user 240 touches the displayed videos to the user, when the user 240 touches the videos displayed by the 3D display module 210 in the interactive 3D system. The spatial tactile stimulus module 220 feedbacks the 3D display output information processed in the interactive 3D middleware and the tactile sensation set in the virtual 3D object context to the user. The user can receive realistic videos by recognizing the tactile stimulus in addition to the visual 3D stimulus. The tactile stimulus may use ultrasonic stimulus or jet air stimulus. That is, the tactile stimulus may be provided to the user by the ultrasonic stimulus providing pressure by concentrating ultrasonic waves or the jet air stimulus providing pressure by general jet compressed air.

The interaction computing module 230 receives sensing information on the 3D space transmitted from the spatial touch recognition module 200 and processes information on the virtual object position and context in the 3D space to perform the middleware role that feedbacks the information to the user through the 3D display and a tactile stimulus interface. The interaction computing module 230 accesses 3D media data and interaction data stored in a high-performance storage connected to the system and processes the data.

In addition, the table type interactive 3D system may include an interactive 3D middleware and contents interworking module. The interactive 3D middleware and contents interworking module processes the 3D related input/output information in the interactive 3D system and recognizes and analyzes behaviors of a person present in the real 3D space based on the input 3D spatial information and outputs the virtual 3D objects to the display to perform the interaction with the user.

In addition, although exemplary embodiments of the present invention have been illustrated and described, the present invention is not limited to the above-mentioned embodiments and various modified embodiments can be made by those skilled in the art within the scope of the appended claims of the present invention. In addition, these modified embodiments should not be seen as separate from the technical spirit or prospects outlined herein.

What is claimed is:

1. An interactive 3D system, comprising:
a table type 3D display module displaying 3D videos;
a spatial touch recognition module monitoring a position of user's fingers interacting with the displayed 3D videos; and
an interaction computing module controlling the 3D display module and the spatial touch recognition module.

2. The system of claim 1, wherein the spatial touch recognition module includes a 3D camera capturing the position of the user's fingers by using a time when output infrared pulses are reflected and returned from objects.

3. The system of claim 2, further comprising a spatial tactile stimulus module providing tactile information with the fingers when the user's fingers interacting with the displayed 3D videos are positioned at a specific point.

4. The system of claim 3, wherein the spatial tactile stimulus module includes at least one of an ultrasonic stimulus module providing pressure by concentrating ultrasonic waves and a jet air stimulus module providing pressure by jet compressed air.

5. An interactive 3D system, comprising:
a table type 3D display module displaying 3D videos;
a spatial touch recognition module monitoring a position of user's fingers interacting with the displayed 3D videos;
an interaction computing module controlling the 3D display module and the spatial touch recognition module; and
a spatial tactile stimulus module providing tactile information with the fingers when the user's fingers interacting with the displayed 3D videos are positioned at a specific point.

6. The system of claim 5, wherein the spatial tactile stimulus module includes at least one of an ultrasonic stimulus module providing pressure by concentrating ultrasonic waves and a jet air stimulus module providing pressure by jet compressed air.

7. The system of claim 6, further comprising a flash hologram display module implementing a flash hologram display function in addition to the 3D display module.
